(19) United States
(12) Patent Application Publication
(10) Pub. No.: US 2004/0154412 A1
(43) Pub. Date: Aug. 12, 2004

(54) Cross-axial sensor for measuring magnetic fields emanating from magnetoelastic shafts

(76) Inventors: Jeffrey L. Viola, Berkley, MI (US); William T. Moore, Ypsilanti, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/361,319

(22) Filed: Feb. 10, 2003

(51) Int. Cl. G01L 3/02

(52) U.S. Cl. 73/862.331

(57) ABSTRACT

A sensor for measuring divergent magnetic fields emanating from a rotatable magnetoelastic shaft without directly contacting the shaft comprises diametrically opposed sensing elements held in spaced relation to the shaft. Each sensing element is adjacent a corresponding one of the magnetic zones and on opposite sides of the shaft so as to create a cross-axial sensor arrangement.

### CROSS-REFERENCE TO RELATED APPLICATIONS

This application claims the benefit of U.S. patent application Ser. No. 10/193,754, filed on Jul. 11, 2002, the description of which is incorporated herein by reference.

### BACKGROUND OF INVENTION

1. Field of the Invention

This invention relates in general to measuring and testing and more particularly relates to an apparatus for measuring magnetic fields. Most particularly, the invention relates to a sensor for measuring divergent magnetic fields emanating from a magnetoelastic shaft.

2. Description of the Prior Art

Sensors for measuring divergent magnetic fields emanating from a magnetoelastic shaft are well known. Such sensors are commonly comprised of four sensor pick-ups. Two pick-ups are provided in two magnetic zones. All four pick-ups are required to obtain necessary rotational variation levels and a common mode rejection of uniform magnetic fields, such as the earth's magnetic field.

What is needed is a sensor that reduces the number of sensor pick-ups required, which, in turn, reduces cost and complexity of the sensor.

### SUMMARY OF INVENTION

Generally speaking, the present invention is directed towards a sensor that meets the foregoing needs. The sensor measures divergent magnetic fields emanating from a rotatable magnetoelastic shaft without directly contacting the shaft. The sensor comprises diametrically opposed sensing elements held in spaced relation to the shaft. Each sensing element is adjacent a corresponding one of the magnetic zones and on opposite sides of the shaft so as to create a cross-axial sensor arrangement.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a diagrammatic representation of a dual axial sensor for measuring divergent magnetic fields emanating from a magnetoelastic shaft.

FIG. 2 is a diagrammatic representation of a cross-axial sensor.

FIG. 3 is a diagrammatic representation of a dual cross-axial sensor.

### DETAILED DESCRIPTION

Referring now to the drawings, wherein like numerals designate like components throughout all of the several Figures, there is illustrated in FIG. 1 a sensor 10a on a rotatable shaft 12 for measuring divergent magnetic fields B1, B2 emanating from the shaft 12 without directly contacting the shaft 12. The shaft 12 can be made of a magnetic alloy, wherein the magnetic alloy is a material component of the shaft 12, or carry a magnetic alloy layer on its outer peripheral surface. When a torque is transmitted to the shaft 12, the magnetic alloy is mechanically stressed or otherwise deformed. This causes magnetic fields B1, B2 to emanate from the magnetic alloy. A component of the magnetic field B1, B2 is sensed by the sensor 10a to produce an output signal that correlates to a direction and magnitude of the torque transmitted to the shaft 12.

The sensor 10a illustrated in FIG. 1 has two sensing or pick-up elements, each of which is preferably in the form of a coil pair 14, 16. The coil pairs 14, 16 are held in spaced relation to the shaft 12. This can be accomplished with any suitable support. As illustrated in FIG. 1, each coil pair 14, 16 includes two corresponding axially arranged coils 14a, 14b and 16a, 16b that are in the same plane P1, P2. The coils 14a, 14b and 16a, 16b of each coil pair 14, 16 are arranged in an opposite sensing configuration, as indicated by the directional arrows adjacent the coils 14a, 14b, and 16a, 16b when viewing FIG. 1. The coils 14a, 14b and 16a, 16b are also in equal and opposite magnetic fields B1, B2, which emanate from corresponding magnetic zones 12a, 12b of the shaft 12. This cancels out uniform magnetic fields, such as the earth's magnetic field, which are common to the coils 14a, 14b and 16a, 16b. The coil pairs 14, 16 are also diametrically opposed (i.e., placed 180-degrees apart around the shaft 12) in order to cancel the undesirable effects, such as gain and offset changes due to relative radial position changes between the shaft 12 and coil pairs 14, 16. These effects require the arrangement of four coils 14a, 14b and 16a, 16b, two coils 14a, 16a and 14b, 16b adjacent each respective magnetic zone 12a, 12b, resulting in a dual axial sensor arrangement.

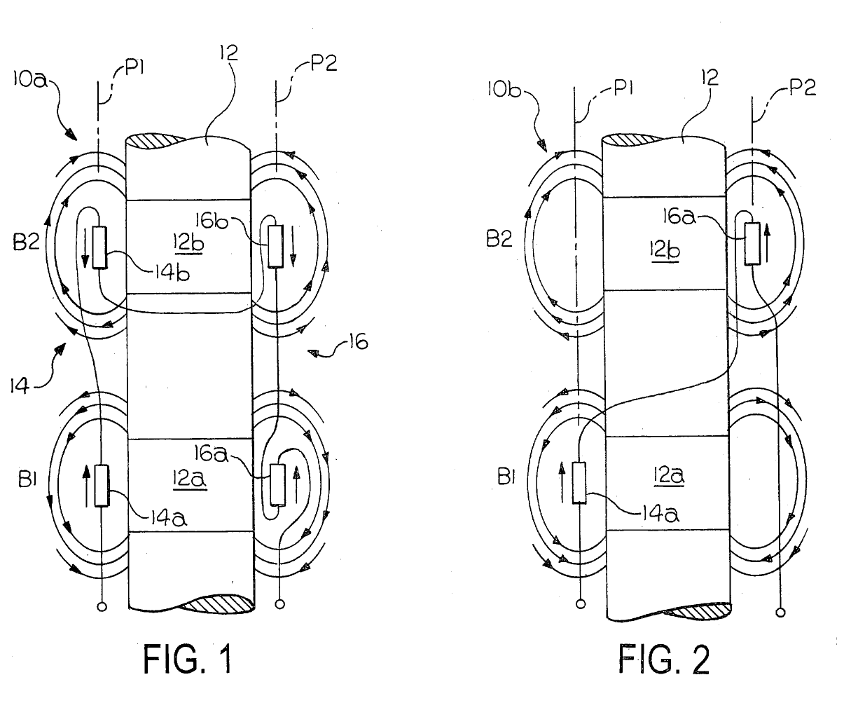

If there is a reasonable correlation between the two adjacent magnetic zones 12a, 12b, one of the diametrically opposed coils 16a adjacent the same magnetic zone 12a can be axially displaced into the adjacent magnetic zone 12b, as shown in FIG. 2. This creates a cross-axial sensor arrangement, as generally indicated at 10b in FIG. 2. In this arrangement, there is one coil 14a, 16a adjacent each respective magnetic zone 12a, 12b and the coils 14a, 16a are in close parallel planes P1, P2. This allows the two relatively equal and opposite magnetic fields B1, B2 to be measured by the two coils 14a, 16a, which are in opposite sensing configurations, as indicated by the directional arrows adjacent the coils 14a, 16a when viewing FIG. 2, while canceling uniform magnetic fields. In addition, the coils 14a, 16a are on opposite sides of the shaft 12, or spaced circumferentially 180-degrees apart. This allows an averaging of a periodic signal, causing a reduction in rotational variation while still compensating for the radial relative motions of the shaft 12 with respect to the locations of the coils 14a, 16a. Again, this assumes a close correlation between the two magnetic zones 12a, 12b. Since the magnetic zones 12a, 12b are adjacent to each other and reside on portions of the shaft 12 that have gone through identical forming, heat-treating, machining, and magnetizing processes, the correlation should be very good.

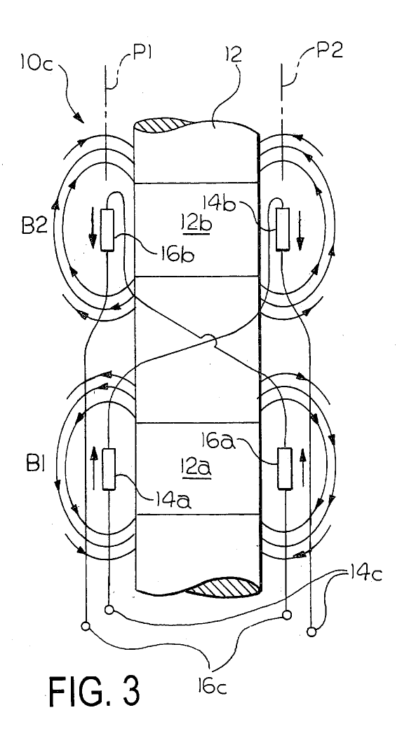

Unless there is perfect correlation between magnetic zones 12a, 12b, there is, of course, the potential for an increase in rotational error. Also, there can be a reduction in uniform field cancellation due to the additional displacement between the parallel planes P1, P2 in which the coils 14a, 16a now reside. These two effects have proven to be reasonable from a signal-to-noise perspective. However, since the rotational error and uniform field cancellation can be cancelled out by the physical averaging and placing of the coils, a mathematical averaging can be performed on two separate coil pairs 14a, 14b and 16a, 16b in a dual cross-axial sensor arrangement, as generally indicated at 10c in FIG. 3. One coil pair 14a, 14b is disposed 180-degrees from the other coil pair 16a, 16b. Through mathematical averaging, the signal performance (i.e., the uniform field cancellation and rotational signal reduction) can be regenerated with the same number of coils 14a, 14b and 16a, 16b but two separate channels or redundant outputs 14c, 16c. Each cross-axial pair 14a, 14b and 16a, 16b may have slightly less performance but the final averaged signal should be substantially identical to having four elements in combination, as illustrated in FIG. 1. This higher performance signal, instead of the individual signals, can now be used for control purposes. Moreover, this allows safety critical applications to have redundant pairs 14a, 14b and 16a, 16b without the loss of performance.

While this invention has been described with respect to several preferred embodiments, various modifications and additions will become apparent to persons of ordinary skill in the art. All such variations, modifications, and variations are intended to be encompassed within the scope of this patent, which is limited only by the claims appended hereto.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. In combination:
a shaft; and
a sensor for measuring divergent magnetic fields emanating from magnetic zones on the shaft, the sensor comprising:
diametrically opposed sensing elements held in spaced relation to the shaft, each sensing element being adjacent a corresponding one of the magnetic zones and on opposite sides of the shaft so as to create a cross-axial sensor arrangement.

2. The sensor according to claim 1 wherein the sensing elements are coils.

3. The sensor according to claim 1 wherein the sensing elements are in close parallel planes.

4. The sensor according to claim 1 wherein the sensing elements are in opposite sensing configurations so as to cancel uniform magnetic fields.

5. The sensor according to claim 1 wherein the magnetic zones reside on portions of the shaft which have gone through substantially identical forming, heat-treating, machining, and magnetizing processes.

6. The sensor according to claim 1 wherein the sensing elements are coil pairs held in spaced relation to the shaft and in a dual cross-axial sensor arrangement, a first one of the coil pairs being disposed 180-degrees from a second one of the coil pairs.

7. The sensor according to claim 1 wherein the two coil pairs have separate outputs.

8. The sensor according to claim 7 further comprising means for mathematically averaging the outputs.

9. In combination:
a shaft; and
a sensor for measuring two relatively equal and opposite magnetic fields emanating from adjacent magnetic zones on the shaft, the sensor comprising:
a pair of diametrically opposed coils held in spaced relation to the shaft, a first one of the coils being adjacent a first one of the magnetic zones and a second one of the coils being adjacent a second one of the magnetic zones and the coils are on opposite sides of the shaft so as to create a cross-axial sensor arrangement.

10. The sensor according to claim 9 wherein the coils are in close parallel planes.

11. The sensor according to claim 9 wherein the coils are in opposite sensing configurations so as to cancel uniform magnetic fields.

12. The sensor according to claim 9 wherein the magnetic zones reside on portions of the shaft which have gone through substantially identical forming, heat-treating, machining, and magnetizing processes.

13. In combination:
a shaft; and
a sensor for measuring two relatively equal and opposite magnetic fields emanating from adjacent magnetic zones on the shaft, the sensor comprising:
two coil pairs held in spaced relation to the shaft and in a dual cross-axial sensor arrangement, a first one of the coil pairs being disposed 180-degrees from a second one of the coil pair,

14. The sensor according to claim 13 wherein the two coil pairs have separate outputs.

15. The sensor according to claim 13 further comprising means for mathematically averaging the outputs.
